(19) United States
(12) Patent Application Publication
(10) Pub. No.: US 2026/0234885 A1
(43) Pub. Date: Aug. 13, 2026

(54) GRAPPLE BUCKET

(71) Applicant: Weedoo Greenboat, Inc., West Palm Beach, FL (US)

(72) Inventors: Tara LORDI, Wellington, FL (US); David J. MAGLIATO, Wellington, FL (US)

(21) Appl. No.: 19/408,805

(22) Filed: Dec. 4, 2025

Related U.S. Application Data
(60) Provisional application No. 63/757,780, filed on Feb. 12, 2025.

(51) Int. Cl. E02B 15/10; B63B 35/32; B66C 3/04; B66C 3/20

(52) U.S. Cl. CPC E02B 15/10; B63B 35/32; B66C 3/04; B66C 3/20

(57) ABSTRACT

Embodiments includes a boat. In further embodiments, the boat includes an aquatic vessel; a loader which provides a quick attachment system for connecting to the boat; and a grapple bucket which is connected to the loader for removing large debris and waste.

### BACKGROUND

Aspects of the present invention relate generally to a grapple bucket and, more particularly, to a grapple bucket for a work boat.

### SUMMARY

In a first embodiment, a work boat includes: a boat which includes an aquatic vessel; a loader which provides a quick attachment system for connecting the boat; and a grapple bucket which is connected to the loader for removing large debris and waste.

In a second embodiments, a grapple bucket includes: a plurality of lower tines connected to a lower rectangular tube; a plurality of upper tines connected to an upper rectangular tube; and a plurality of frame posts which connect the lower rectangular tube to the upper rectangular tube.

In a third embodiment, a grapple bucket system includes: a grapple bucket which includes a plurality of lower tines connected to a lower rectangular tube; a plurality of upper tines connected to an upper rectangular tube; and a plurality of frame posts which connect the lower rectangular tube to the upper rectangular tube; and a loader which is connected to the grapple bucket.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a grapple bucket according to embodiments of the present invention.

FIG. 2 depicts the grapple bucket according to embodiments of the present invention.

FIG. 3 is a first example of the grapple bucket for a work boat according to embodiments of the present invention.

FIG. 4 is a second example of the grapple bucket for the work boat according to embodiments of the present invention.

FIG. 5 is a third example of the grapple bucket for the work boat according to embodiments of the present invention.

FIG. 6 is a fourth example of the grapple bucket with a loader for the work boat according to embodiments of the present invention.

FIG. 7 is a fifth example of the grapple bucket with the loader for the work boat in according to embodiments of the present invention.

FIG. 8 is a sixth example of the grapple bucket according to embodiments of the present invention.

FIG. 9 is a seventh example of the grapple bucket according to embodiments of the present invention.

FIG. 10 is an eighth example of the grapple bucket according to embodiments of the present invention.

FIG. 11 is a ninth example of the grapple bucket according to embodiments of the present invention.

FIG. 12 is a tenth example of the grapple bucket according to embodiments of the present invention.

FIG. 13 is an eleventh example of the grapple bucket according to embodiments of the present invention.

FIG. 14 is a twelfth example of the grapple bucket according to embodiments of the present invention.

### DETAILED DESCRIPTION

Aspects of the present invention relate generally to a grapple bucket and, more particularly, to a grapple bucket for a work boat. Embodiments of the invention provide the grapple bucket which is configured for picking up heavy objects and large debris within an aquatic environment. In further embodiments, the grapple bucket is constructed of rugged steel and is configured to be compatible with a quick-change attachment system. Accordingly, the quick-change attachment system with the grapple bucket allows seamless transitions between different tools. In further aspects of the present invention, the grapple bucket is configured to pick up aquatic weeds, large branches, or bulk waste.

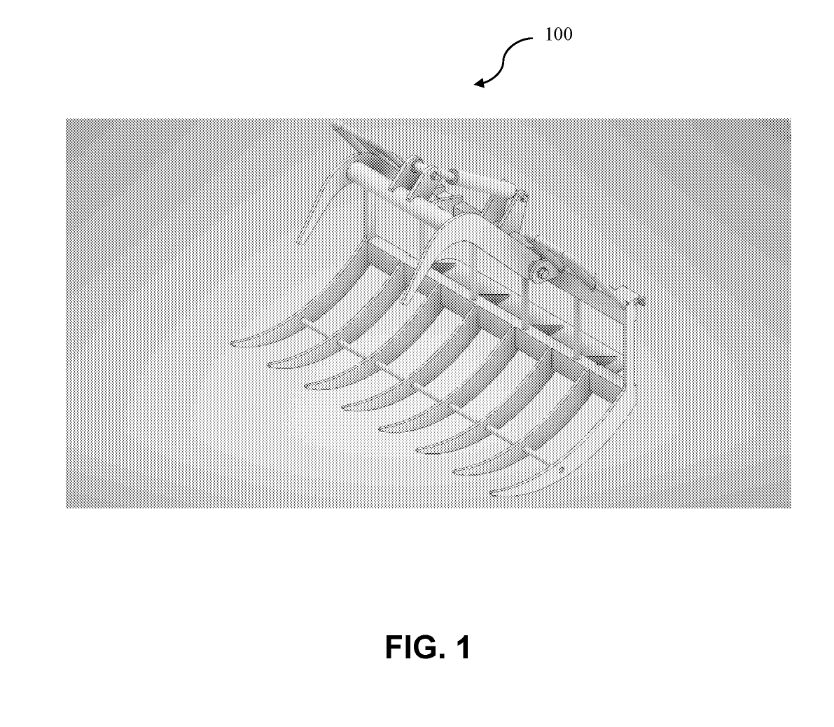

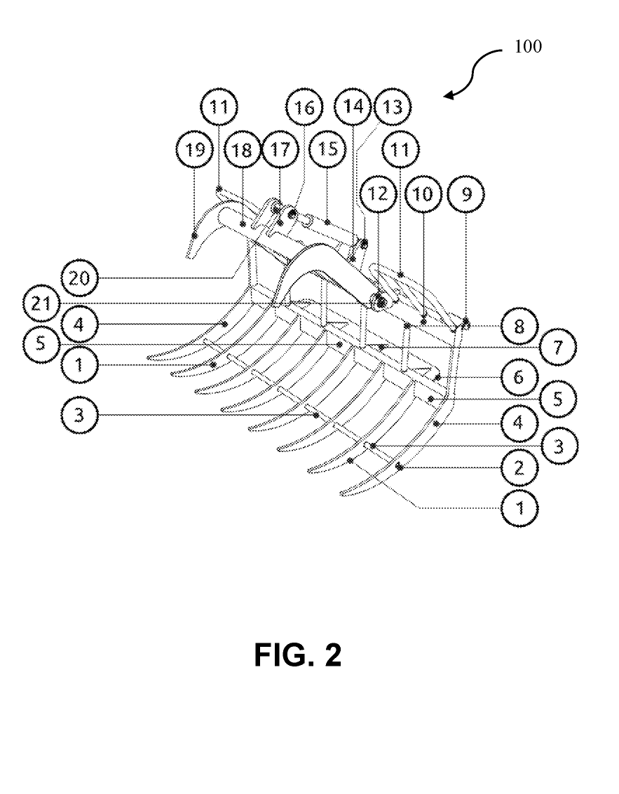

FIG. 1 depicts an exemplary grapple bucket 100 for the work boat according to embodiments of the present invention. In specific embodiments and as depicted in FIG. 2, the exemplary grapple bucket 100 includes lower tines 1, a hole 2 for the lower tines, and a crossbar 3 which goes thru the hole 2 in the lower tines 1. The exemplary grapple bucket 100 also includes outer tines 4, a lower rectangular tube 5, a bucket foil 6, a bucket foil gusset 7, a plurality of frame posts 8, a bracket hook 9, an upper rectangular tube 10 (e.g., a frame), a rolled upper rail 11, and a first set of plurality of mounting ears 12 for mounting upper tines 19 to the upper rectangular tube 10 (e.g., the frame). The exemplary grapple bucket 100 also includes a hexagonal cap screw 13, a second mounting ear 14 to mount a hydraulic cylinder 15, another hexagonal cap screw 16, a third mounting ear 17 for mounting the hydraulic cylinder 15 to a crossbar 18 for the upper tines 19. The exemplary grapple bucket 100 further includes a cross tube 20, and a plurality of greasable bolts 21. In embodiments, the lower tines 1 and the upper tines 19 are slender pointed projecting parts which allow for the grapple bucket 100 to pick up aquatic weeds, large branches, or bulk waste.

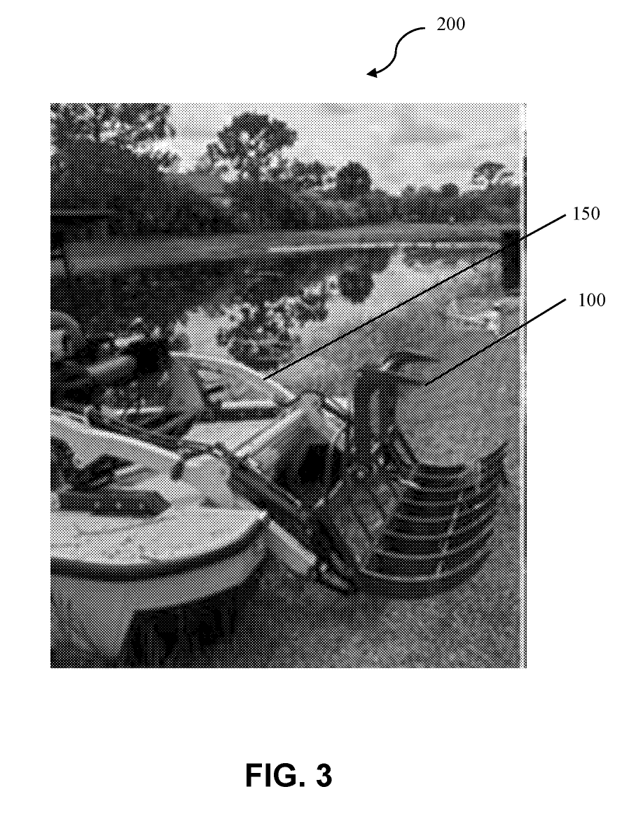

FIG. 3 is a first example of the grapple bucket for a work boat according to embodiments of the invention. More specifically, FIG. 3 shows a work boat 200 which is configured to include a boat 150 attached to the grapple bucket 100 via a quick-attachment system. In further embodiments, the boat 150 may comprise any aquatic vessel, aquatic weed harvester, or any aquatic work environment for traversing and cleaning waterways (e.g., the boat 150) is configured with the grapple bucket and a loader to traverse and clean aquatic weeds, large branches, bulk waste, heavy objects, and large debris within the waterways).

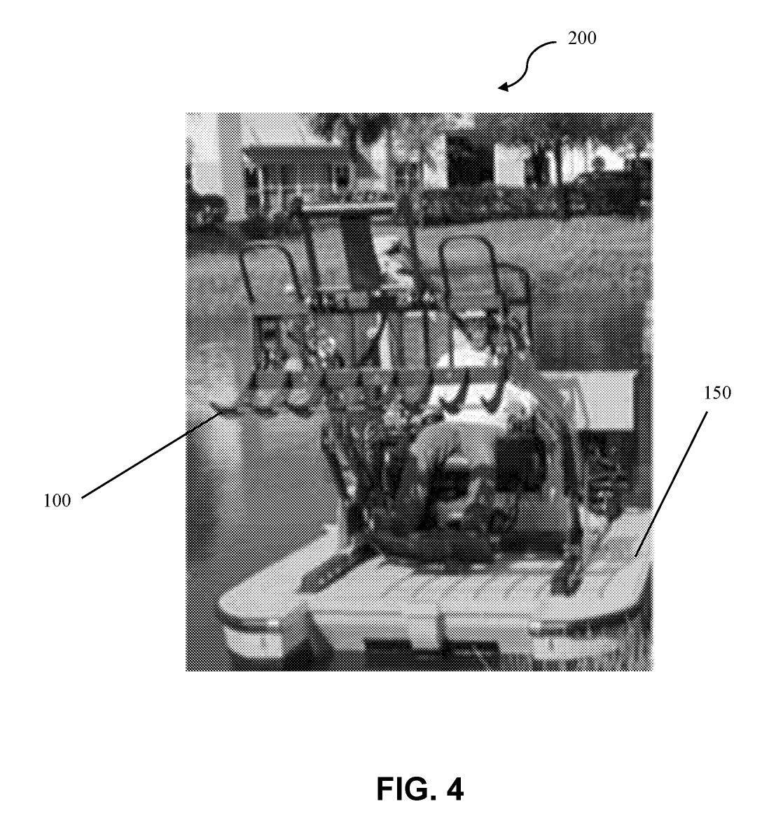

FIG. 4 is a second example of the grapple bucket for the work boat according to embodiments of the invention. More specifically, FIG. 4 shows the work boat 200 which is configured to include the boat 150 attached to the grapple bucket 100 via the quick-attachment system. In further embodiments, the grapple bucket 100 in FIG. 4 may be lowered to grab large debris and bulk waste and raised to drop off the large debris and bulk waste.

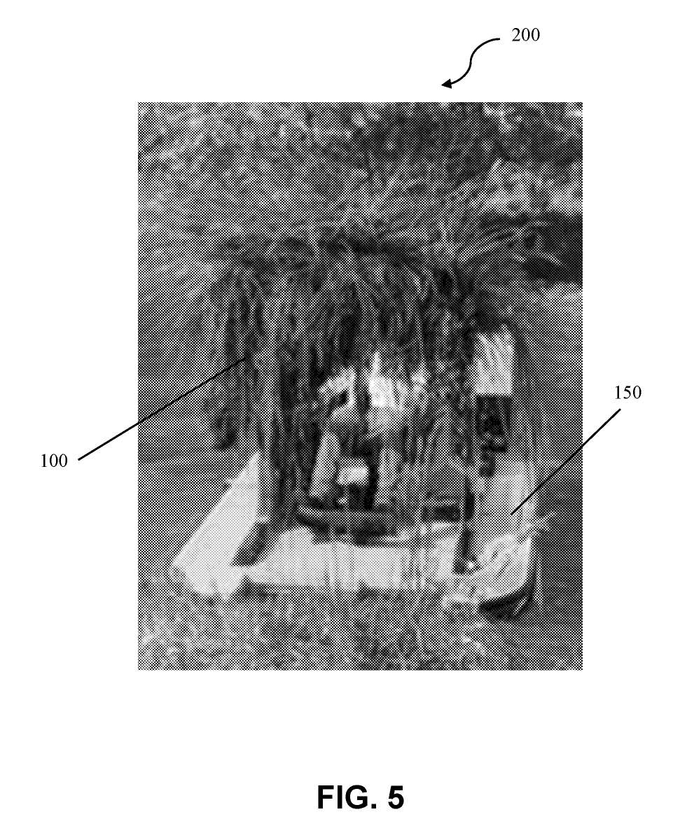

FIG. 5 is a third example of the grapple bucket for the work boat according to embodiments of the invention. More specifically, FIG. 5 shows the work boat 200 which is configured to include the boat 150 attached to the grapple bucket 100 via the quick-attachment system. In further embodiments, the work boat 200 in FIG. 5 includes the grapple backet 100 which has grabbed large debris and bulk waste.

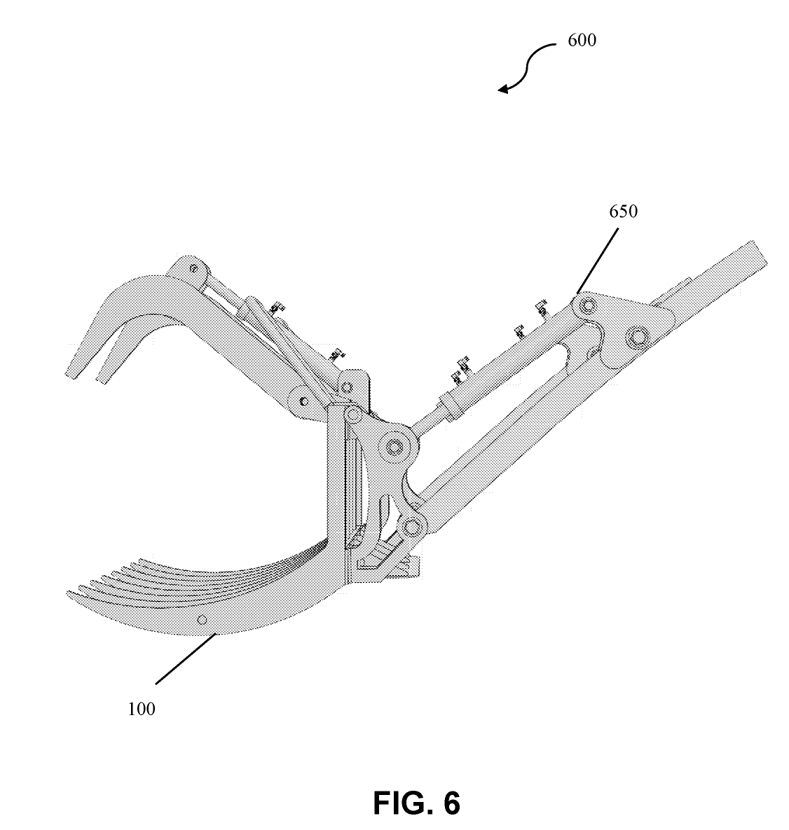

FIG. 6 is a fourth example of the grapple bucket with a loader for the work boat according to embodiments of the present invention. More specifically, FIG. 6 shows the grapple bucket 100 connected to a loader 650. In further embodiments, the loader 650 in FIG. 6 provides the quick-attachment system to connect the grapple backet 100 to the boat 150 for the work boat 200. In aspects of the present invention, the loader 650 comprises rugged steel. In further embodiments, the grapple bucket 100 connected to the loader 650 comprises a grapple bucket system 600.

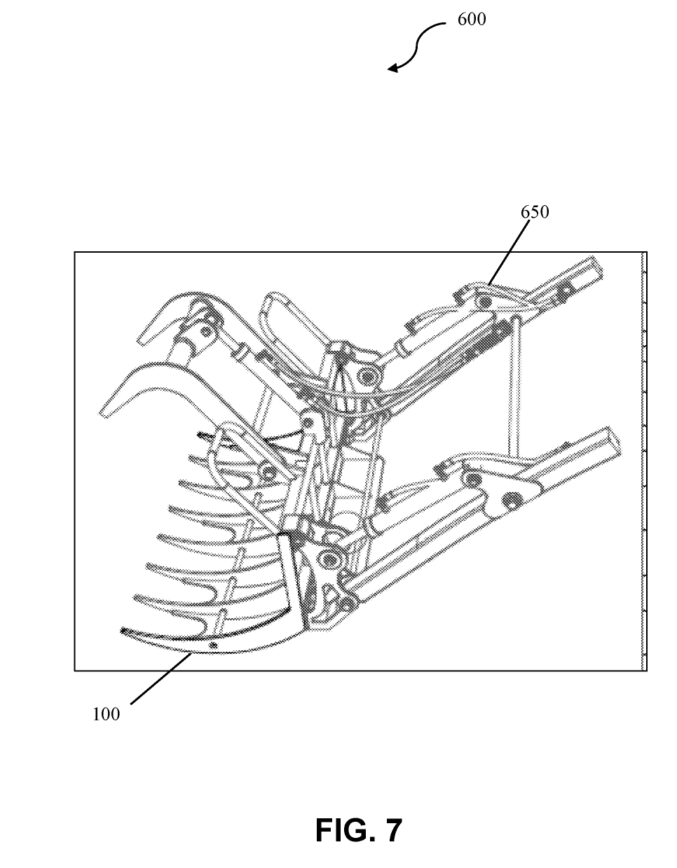

FIG. 7 is a fifth example of the grapple bucket with a loader for the work boat according to embodiments of the present invention. More specifically, FIG. 7 shows the grapple bucket 100 connected to the loader 650. In further embodiments, the loader 650 in FIG. 7 provides the quick-attachment system to connect the grapple backet 100 to the boat 150 for the work boat 200. In aspects of the present invention, the loader 650 comprises rugged steel. In further embodiments, the grapple bucket 100 connected to the loader 650 comprises a grapple bucket system 600.

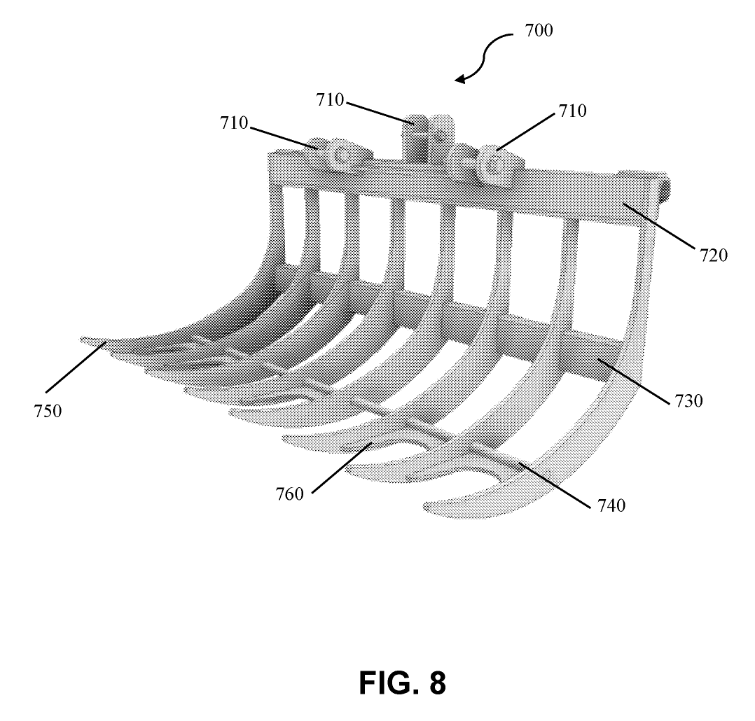

FIG. 8 is a sixth example of the grapple bucket according to embodiments of the present invention. More specifically, FIG. 8 shows an exemplary grapple bucket 700 which includes an upper member 710, an upper horizontal frame 720, a lower horizontal frame 730, a horizontal crossbar 740, a tine 750, and a u shaped cross section 760. In further embodiments, the u shaped cross section 760 enhances the ability of the grapple bucket 700 to pick up aquatic weeds, large branches, or bulk waste. In aspects of the present invention, the u shaped cross section 760 comprises rugged steel.

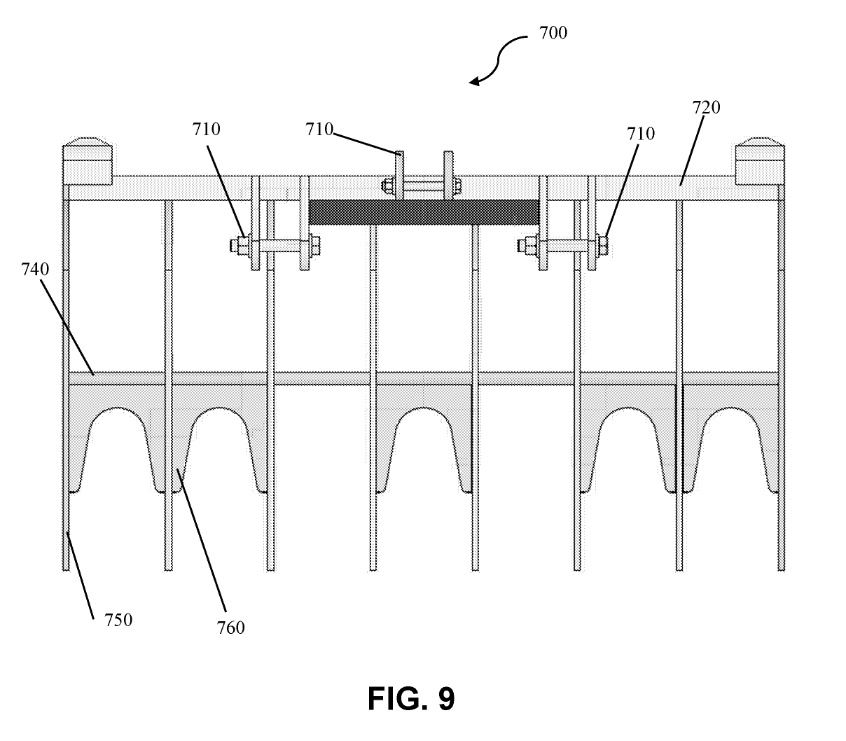

FIG. 9 is a seventh example of the grapple bucket according to embodiments of the present invention. FIG. 9 shows a top view of the grapple bucket 700. The grapple bucket 700 in FIG. 9 shows the upper member 710, the upper horizontal frame 720, the horizontal crossbar 740, the tine 750, and the u shaped cross section 760.

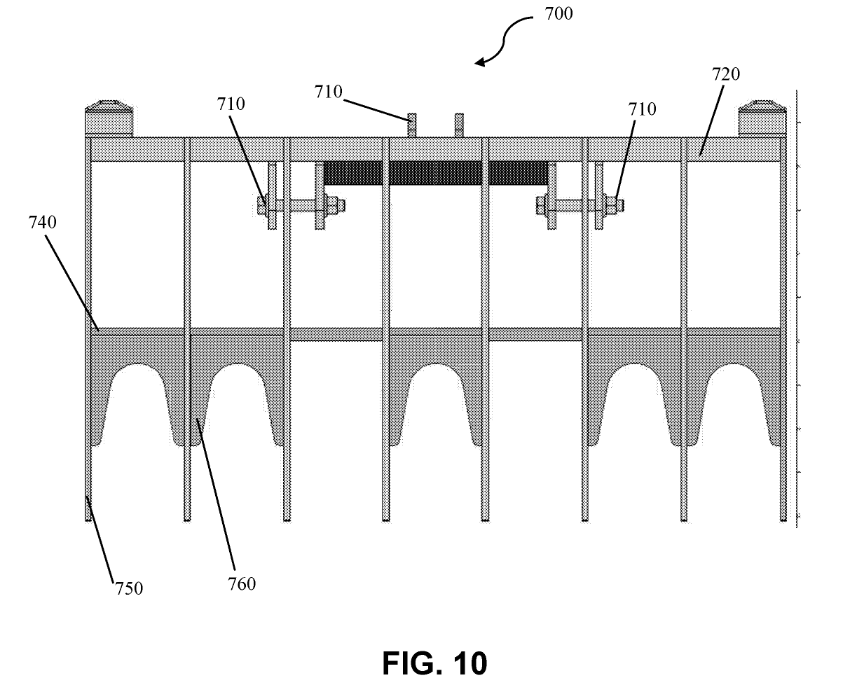

FIG. 10 is an eighth example of the grapple bucket according to embodiments of the present invention. FIG. 10 shows a bottom view of the grapple bucket 700. The grapple bucket 700 in FIG. 10 shows the upper member 710, the upper horizontal frame 720, the horizontal crossbar 740, the tine 750, and the u shaped cross section 760.

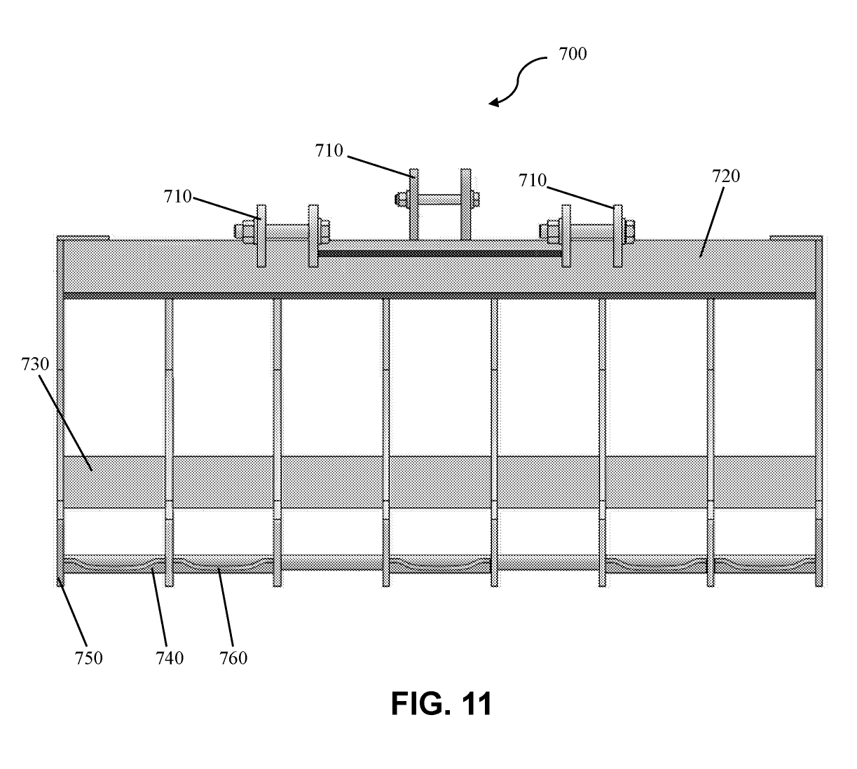

FIG. 11 is a ninth example of the grapple bucket according to embodiments of the present invention. FIG. 11 shows a front view of the grapple bucket 700. The grapple bucket 700 in FIG. 11 shows the upper member 710, the upper horizontal frame 720, the lower horizontal frame 730, the horizontal crossbar 740, the tine 750, and the u shaped cross section 760.

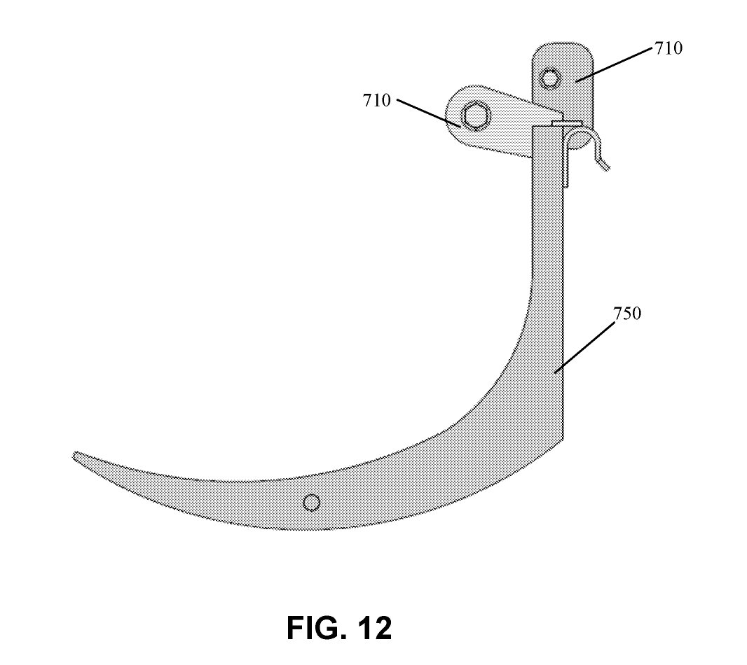

FIG. 12 is a tenth example of the grapple bucket according to embodiments of the present invention. FIG. 12 shows a side view of the grapple bucket 700. The grapple bucket 700 in FIG. 12 shows the upper member 710 and the tine 750.

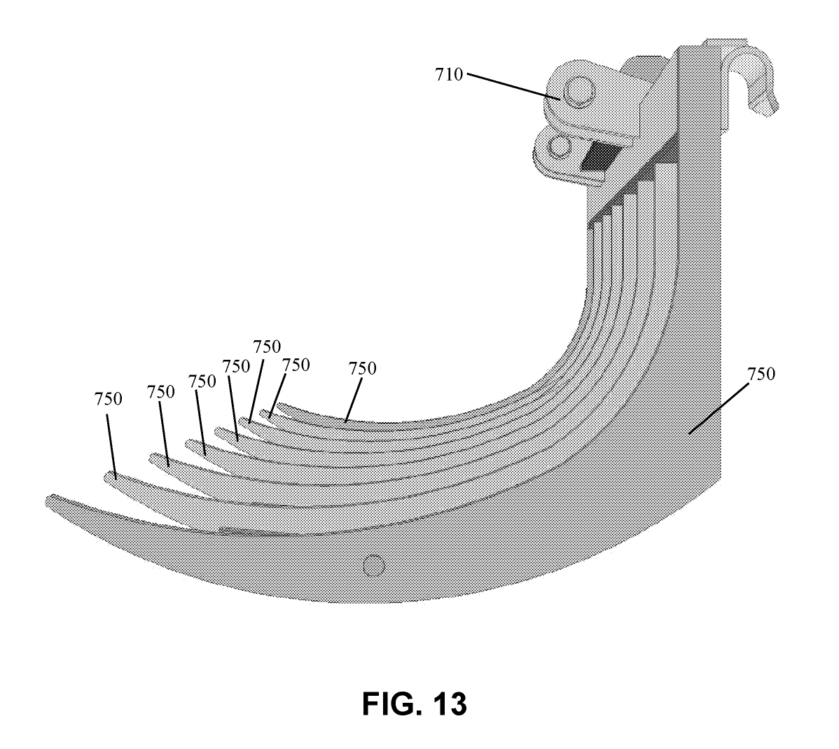

FIG. 13 is an eleventh example of the grapple bucket according to embodiments of the present invention. FIG. 13 shows another side view of the grapple bucket 700. The grapple bucket 700 in FIG. 13 shows the upper member 710 and a plurality of tines 750.

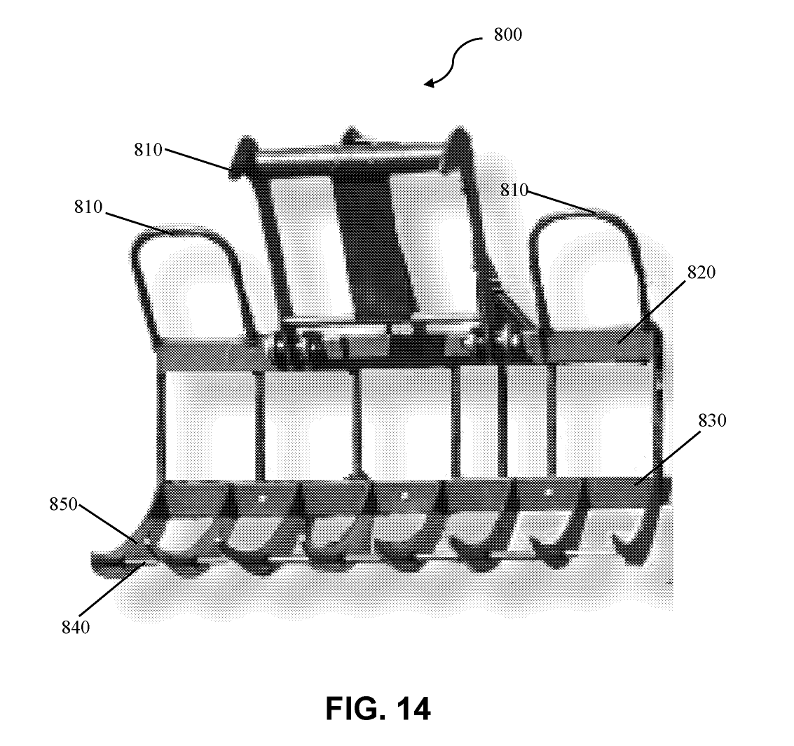

FIG. 14 is a twelfth example of the grapple bucket according to embodiments of the present invention. More specifically, FIG. 14 shows an exemplary grapple bucket 800 which includes an upper member 810, an upper horizontal frame 820, a lower horizontal frame 830, a horizontal crossbar 840, and a tine 850. In further embodiments, the exemplary grapple bucket 800 is configured with a plurality of tines 850 to pick up aquatic weeds, large branches, or bulk waste. In aspects of the present invention, the exemplary grapple bucket 800 comprises rugged steel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A work boat, comprising:
a boat which comprises an aquatic vessel;
a loader which provides a quick attachment system for connecting to the boat; and
a grapple bucket which is connected to the loader for removing large debris and waste.

2. The work boat according to claim 1, wherein the grapple bucket comprises steel.

3. The work boat according to claim 1, wherein the grapple bucket is lowered to grab the large debris and waste.

4. The work boat according to claim 1, wherein the grapple bucket is raised to drop off the large debris and waste.

5. The work boat according to claim 1, wherein the boat comprises the aquatic vessel for traversing waterways.

6. The work boat according to claim 5, wherein the boat comprises the aquatic vessel for also cleaning the waterways with the loader and the grapple bucket.

7. The work boat according to claim 1, wherein the grapple bucket comprises:
a plurality of lower tines connected to a lower rectangular tube;
a plurality of upper tines connected to an upper rectangular tube;
a plurality of frame posts which connect the lower rectangular tube to the upper rectangular tube.

8. A grapple bucket, comprising:
a plurality of lower tines connected to a lower rectangular tube;
a plurality of upper tines connected to an upper rectangular tube; and
a plurality of frame posts which connect the lower rectangular tube to the upper rectangular tube.

9. The grapple bucket according to claim 8, wherein the grapple bucket comprises steel.

10. The grapple bucket according to claim 8, wherein the grapple bucket is lowered to grab the large debris and waste.

11. The grapple bucket according to claim 8, wherein the grapple bucket is raised to drop off the large debris and waste.

12. The grapple bucket according to claim 8, wherein the grapple bucket is connected to a boat via a quick-attachment system.

13. The grapple bucket according to claim 12, wherein the quick-attachment system comprises a loader.

14. A grapple bucket system, comprising:
a grapple bucket which comprises:
a plurality of lower tines connected to a lower rectangular tube;
a plurality of upper tines connected to an upper rectangular tube;
a plurality of frame posts which connect the lower rectangular tube to the upper rectangular tube; and
a loader which is connected to the grapple bucket.

15. The grapple bucket system according to claim 14, wherein the loader comprises a quick-attachment system for connecting the grapple bucket to a boat for raising and lower large debris and waste.

16. The grapple bucket system according to claim 15, wherein the boat comprises the aquatic vessel for traversing waterways.

17. The grapple bucket system according to claim 16, wherein the boat comprises the aquatic vessel for also cleaning the waterways with the loader and the grapple bucket.

18. The grapple bucket system according to claim 14, wherein the grapple bucket comprises steel.

19. The grapple bucket system according to claim 14, wherein the loader comprises steel.

20. The grapple bucket system according to claim 14, wherein the lower tines and the upper tines are slender pointed projecting parts which allow for the grapple bucket to pick up large debris and waste.
